(19) United States
(12) Patent Application Publication
(10) Pub. No.: US 2022/0352771 A1
(43) Pub. Date: Nov. 3, 2022

(54) CORE DISC OR LAMINATED CORE FOR A ROTOR OF AN ELECTRIC MOTOR

(71) Applicant: Mahle International GmbH, Stuttgart (DE)

(72) Inventors: Patrick Altherr, Stuttgart (DE); Stefan Steichele, Gerlingen (DE)

(21) Appl. No.: 17/731,227

(22) Filed: Apr. 27, 2022

(30) Foreign Application Priority Data
Apr. 28, 2021 (DE) 102021204219.8

(51) Int. Cl. H02K 1/22; H02K 7/00

(52) U.S. Cl. CPC H02K 1/22; H02K 7/003

(57) ABSTRACT

A core disc or a laminated core having at least two core discs for a rotor of an electric motor may include an inner lateral surface and at least one radial recess for receiving adhesive arranged on the inner lateral surface.

### CROSS-REFERENCE TO RELATED APPLICATIONS

This application claims priority to German Patent Application No. DE 10 2021 204 219.8, filed on Apr. 28, 2021, the contents of which is hereby incorporated by reference in its entirety.

### TECHNICAL FIELD

The present invention relates to a core disc or to a laminated core having at least two core discs for a rotor of an electric motor with an inner lateral surface. In addition, the invention relates to a rotor of an electric motor having such a laminated core assembled of such core discs and to an electric motor having such a rotor.

### BACKGROUND

From DE10 2014 106 614 A1 a generic core disc for a laminated core of a rotor of an electric motor is known, wherein the individual core discs are slid onto a main shaft of the rotor and are clamped in between two thrust discs that are non-rotatably connected to the main shaft.

Disadvantageous with the rotors known from the prior art frequently is that for a torque-proof connection of individual core discs or of laminated cores to a shaft, in particular a main shaft, of a rotor of an electric motor a so-called slot-and-key connection is utilised, but which is not only extremely complicated to produce, but also brings with it further disadvantages such as for example a merely low capability of a torque transmission and a weakening of a cross-section of the shaft, for example of the main shaft, and a reworking of an outer lateral surface of the shaft. In addition, an increased notch effect can occur in particular through the weakening of the cross-section of the main shaft because of the slot that has to be produced. Such a slot-and-key connection can also be accompanied by a certain imbalance of the main shaft.

### SUMMARY

The present invention therefore deals with the problem of stating for a core disc or a laminated core of the generic type an improved or at least an alternative embodiment which in particular overcomes the disadvantages known from the prior art.

According to the invention, this problem is solved through the subject matter of the independent claim(s). Advantageous embodiments are the subject matter of the dependent claim(s).

The present invention is based on the general idea of providing a core disc for a laminated core or a laminated core with at least two core discs of a rotor on an inner lateral surface with a recess for receiving adhesive, by way of which the core disc and a laminated core assembled from such core discs can be easily yet reliably bonded to an outer lateral surface of a main shaft of a rotor of an electric motor. By way of this joining process that is comparatively cost-effective and easy to handle, in particular the slot-and-key connection that has been employed to date for the torque-proof connection between the core disc and the main shaft of the rotor can be omitted, by way of which all disadvantages accompanied by such slot-and-key connections can be prevented. By bonding the core discs to the main shaft, higher tolerances with respect to the main shaft can be additionally accepted and in particular a reworking of an outer lateral surface of the main shaft omitted, as a result of which further substantial advantages in terms of the manufacture of a rotor equipped with such a laminated core materialise.

In an advantageous further development of the core disc according to the invention, at least one radial recess has a radial depth t of 0.05 mm≤t≤0.7 mm, in particular a radial depth t of t approximately 0.2 mm. By way of such a depth, the recesses can be produced both easily, for example by means of punching, stamping or similar and in particular even simultaneously with the manufacturing of the core disc. A depth t of the radial recesses between 0.05 and 0.7 mm also makes possible providing an adequate bonding gap in order to make possible a reliable and torque-proof bond.

Practically, at least one radial recess is produced by means of punching, milling, stamping or jet-machining. In particular the stamping or punching makes it possible to produce both the recess and also the entire core disc in a single method step, which does not only make possible short cycle times but also low manufacturing costs. Here it is conceivable for example that when punching out such a core disc or such a core ring a stamping of the at least one radial recess on the inner lateral surface of the core disc takes place at the same time. Alternatively it is obviously also conceivable that producing the at least one recess is assigned to a separate method step. The radial recesses can also be introduced only into a laminated core already assembled from multiple core discs without radial recess.

Further, the present invention is based on the general idea of equipping a rotor of an electric motor with a main shaft having core discs according to the preceding paragraphs arranged thereon, wherein the core discs are radially bonded to the main shaft. Such a bonding makes possible in particular higher manufacturing tolerances with respect to the main shaft, in particular with respect to the outer lateral surface of the same, so that in the most favourable of cases an elaborate reworking necessary in the past can even be entirely omitted, as a result of which the manufacturing costs can likewise be reduced.

In a further advantageous embodiment of the rotor according to the invention, the balancing disc and/or the drive flange are/is bonded, welded or pressed to the main shaft. When according to the invention the individual core discs of the laminated cores are bonded to the main shaft, it is opportune to also connect in addition the balancing disc or the drive flange to the main shaft of the rotor in a torque-proof manner via a bonded connection. Alternatively it is obviously also conceivable that the same can be connected to the main shaft via a pure press fit, for example a thermal joining fit.

In a further advantageous embodiment of the rotor according to the invention, at least one core disc is connected to the main shaft via a shrink-bonded fit. Such a shrink-bonded fit offers the great advantage that the main shaft is initially cooled and/or the core disc to be joined thereon or the laminated core to be joined thereon heated, as a result of which an enlarged radial gap materialises between an outer lateral surface of the main shaft and an inner lateral surface of the respective core disc. This gap resulting from the heating of the core disc and/or cooling of the main shaft can be used for applying the adhesive, so that an adhesive application prior to sliding the core discs onto the main shaft is possible without the adhesive being pushed off during the subsequent sliding-on. During a subsequent temperature equalisation, the core disc contracts and the main shaft expands, as a result of which the adhesive gap is reduced and in addition to the bonding, a press fit can even be realised under certain conditions. By way of the shrink-bonding or a shrink-bonded fit, higher manufacturing inaccuracies can be tolerated, which makes possible a more cost-effective manufacture both of the core discs and also of the main shaft.

In a further advantageous embodiment of the rotor according to the invention, an electrical insulating layer is arranged between the main shaft and the laminated cores. In connection with the thermal joining, such a large radial gap between the main shaft and the inner lateral surface of the respective core disc can be achieved so that even after the application of the electrical insulating layer and of the adhesive, a sufficiently large radial gap remains because of the cooled main shaft and/or of the heated core discs so that the core disc can be slid over the main shaft without having to fear undesirably wiping off an anaerobic adhesive. By way of a shrink-bonded fit it is additionally possible in this case to connect the laminated cores or generally the core discs to the main shaft with a sufficiently large force fit and at the same time provide and avoid damaging an insulating layer present between the adhesive layer and the main shaft.

In a further advantageous embodiment of the rotor according to the invention, the main shaft is formed hollow, wherein the drive flange comprises an axial extension whose outer diameter is formed complementarily to an inner diameter of the main shaft and which, with mounted rotor, engages in the main shaft. Here, the drive flange comprises a collar which with mounted rotor lies axially against the main shaft and against an adjacent core disc. Here, mounting the drive flange on/in the main shaft can likewise take place via a thermal joining fit or a press fit or an adhesive bond but also by a welding. By way of the balancing disc and the drive flange, the laminated cores arranged in between in the axial direction can be clamped, wherein to increase the torque transmission capability, a bonding of a core disc arranged adjacently to the collar of the drive flange to the collar is also possible. Additionally or alternatively, the core disc arranged at the other end of the laminated cores can also be bonded to a collar of the balancing disc.

Further, the present invention is based on the general idea of equipping an electric motor with a rotor described in the preceding paragraphs by way of which it is possible to form the rotor altogether more cost-effectively.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

There it shows, in each case schematically,

FIG. 1 shows a longitudinal section through a rotor according to the invention with core discs according to the invention,

FIG. 2 shows an axial front view of a core disc of a laminated core for such a rotor according to the invention.

### DETAILED DESCRIPTION

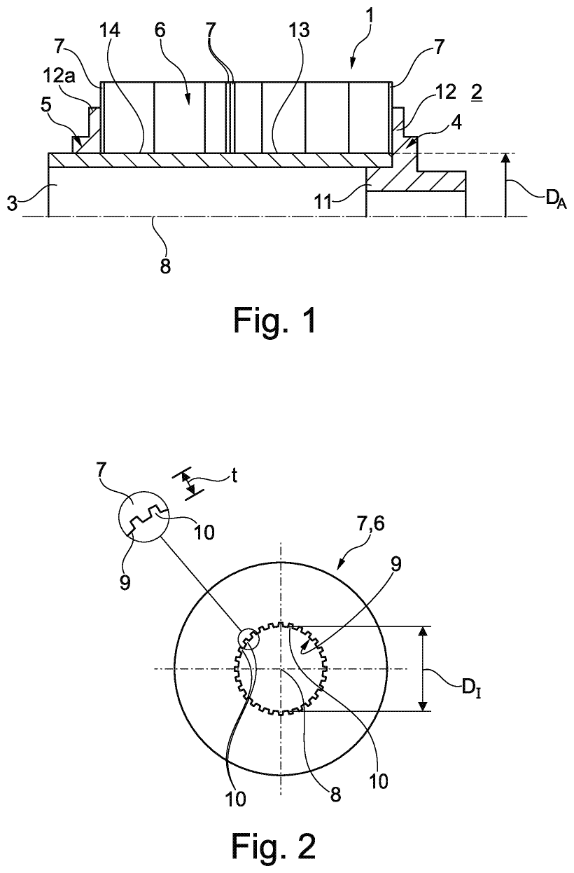

According to FIG. 1, a rotor 1 according to the invention of an electric motor 2 which is not otherwise shown in more detail, comprises a main shaft 3 which in this case is formed as a hollow shaft, and a drive flange 4 and a balancing disc 5. Between the balancing disc 5 and the drive flange 4, laminated cores 6 with individual core discs 7 (see in particular FIG. 2) are arranged on an outer lateral surface of the main shaft 3. Here, the rotor 1 is rotatably mounted in the electric motor 2 about an axis 8. According to the invention, at least one radial recess 10 for receiving adhesive is now provided on an inner lateral surface 9, by way of which it is possible to fix the core discs 7 or laminated cores 6 on the outer lateral surface of the main shaft 3 via a bonded connection 13.

Compared with previously known connecting techniques that are complicated in terms of manufacture and thus also expensive to produce, for example by way of a slot-and-key connection, a simple bonding can make possible a significant reduction of the effort and thus a significant reduction of the costs.

Purely theoretically it is also conceivable that the at least one radial recess 10 for receiving adhesive can only be introduced after an assembly into a laminated core 6. In this case, the individual core discs 7 initially have no radial recess 10.

The at least one radial recess 10 has a radial depth t of 0.05 mm≤t≤0.7 mm, in particular a radial depth t of t approximately 0.2 mm. Such a depth t is sufficient in order to create a necessary adhesive gap and receive sufficient adhesive for a reliable bonded connection 13. The at least one radial recess 10 can be produced for example by means of punching, milling, stamping or jet-machining*, as a result of which not only a cost-effective but at the same time a high-quality manufacture is possible.

Since with adhesives there is an ideal adhesive thickness, the same can be easily predetermined by choosing the radial depth t of the axial recesses 10. The core discs 7 can be firmly pressed onto the main shaft 3 and the radial recesses 10 ensure the adhesive gap and thus the adhesive thickness.

At least one core disc 7 can also be embodied so that its inner diameter is smaller than an outer diameter of the main shaft 3. For example, an inner diameter of at least one core disc 7 can be 0.005 mm to 0.20 mm smaller than an outer diameter of the main shaft 3. By way of this, a reliable press fit can be ensured.

Viewing FIG. 1 further it is noticeable that the main shaft 3 is formed hollow and the drive flange 4 comprises an axial extension 11, whose outer diameter is formed complementarily to an inner diameter of the main shaft 3 and which, with mounted rotor 1, engages in the main shaft 3. In addition, the drive flange 4 has a collar 12 which, with mounted rotor 1, axially lies against the main shaft 3 and against an adjacent core disc 7 and can be bonded for example to the main shaft 3 and/or to the adjacent core disc 7 for increasing a transmittable torque. In the same way, a collar 12a of the balancing disc 5 can obviously also be bonded to the adjacent core disc 7. A fixing of the drive flange 4 via its axial extension 11 engaging in the main shaft 3 can likewise take place via a bonding, in addition or alternatively obviously also by way of a pressing or welding.

At least one core disc 7 can also be embodied so that an inner diameter Di of the inner lateral surface 9 is smaller than an associated outer diameter DA of the main shaft 3, as a result of which a press fit is created. Here, the inner diameter Di of the inner lateral surface 9 of at least one core disc 7 can be at least 0.005 mm to 0.20 mm smaller than the outer diameter DA of the main shaft 3.

Between the main shaft 3 and the laminated cores 6, an electrical insulating layer 14 can be additionally arranged in order to electrically insulate the laminated core 6 against the main shaft 3.

In a further advantageous embodiment of the rotor 1 according to the invention, at least one core disc 7 is connected to the main shaft 3 via a shrink-bonding fit. Such a shrink-bonding fit offers the major advantage of combining a thermal joining method with a bonding method. By heating the core discs 7 or the laminated cores 6 and/or cooling the main shaft 3, a radial gap can be created between the inner lateral surface 9 of the core discs 7 and the outer lateral surface of the main shaft 3 that is so large that when sliding the core disc 7 onto the main shaft an undesirable wiping-off in particular of an anaerobic adhesive during the assembly can be prevented. By way of a subsequent temperature equalisation, the core discs 7 contract and the main shaft 3 expands as a result of which the thermal joining fit is established. In the case of a shrink-bonding fit, an inner diameter of the laminated cores 6 or of the core discs 7 can be embodied so that during the thermal joining an adequate gap is created so that the laminated cores 6 can be joined without force and without substantial damage to the adhesive film or the electrical insulating layer 14. By way of such a shrink-bonding it is possible to connect the laminated cores 6 to the main shaft 3 with a sufficient force fit and at the same time realise the insulating layer 14 between the laminated cores 6 and the main shaft 3. By way of such an adhesive connection 13 between the laminated cores 6 and the outer lateral surface of the main shaft 3, higher manufacturing inaccuracy and dimensional inaccuracies can be additionally tolerated as a result of which producing the rotor 1 according to the invention does not only become simpler in terms of manufacturing but also more cost-effective.

The electrical insulating layer 14 also has a positive effect in particular on a magnetic field, as a result of which the electric motor 2 achieves a greater efficiency.

All in all, a fastening of the core disc 7 or of the laminated cores 6 on the main shaft 3 of the rotor 1 can take place with the core discs 7 according to the invention, the rotor 1 according to the invention and the electric motor 2 without the disadvantages known to date from the prior art.

1. A core disc or a laminated core having at least two core discs for a rotor of an electric motor, comprising:
an inner lateral surface; and
at least one radial recess for receiving adhesive arranged on the inner lateral surface.

2. The core disc or laminated core according to claim 1, wherein the at least one radial recess has a radial depth of 0.05 mm to 0.7 mm.

3. The core disc or laminated core according to claim 1, wherein the at least one radial recess is configured as at least one of a punched recess, a milled recess, a stamped recess, and a jet-machined recess.

4. A rotor of an electric motor, comprising:
a main shaft;
at least one of a drive flange and a balancing disc; and
a laminated core with at least two core discs according to claim 1; and
wherein at least one core disc of the at least two core discs is radially bonded to the main shaft.

5. The rotor according to claim 4, wherein the at least one of the balancing disc and the drive flange is at least one of bonded, welded, and pressed to the main shaft.

6. The rotor according to claim 4, wherein at least one core disc of the at least two core discs is connected to the main shaft via a shrink-bonding fit.

7. The rotor according to claim 4, further comprising an electrical insulating layer arranged between the main shaft and the laminated core.

8. The rotor according to claim 4, wherein:
the main shaft is hollow;
the drive flange includes an axial extension having an outer diameter complementarily to an inner diameter of the main shaft;
the axial extension engages in the main shaft;
the drive flange further includes a collar, which axially lies against the main shaft and against an adjacent core disc of the at least two core discs; and
the collar is bonded to at least one of the main shaft and the adjacent core disc.

9. The rotor according to claim 4, wherein at least one core disc of the at least two core discs is configured such that an inner diameter of the inner lateral surface is smaller than an associated outer diameter of the main shaft.

10. The rotor according to claim 9, wherein the inner diameter of the inner lateral surface of the at least one core disc is 0.005 mm to 0.20 mm smaller than the outer diameter of the main shaft.

11. An electric motor, comprising a rotor according to claim 4.

12. The core disc or laminated core according to claim 1, wherein the at least one radial recess has a radial depth of 0.2 mm.

13. A laminated core for a rotor of an electrical motor, comprising at least two core discs, at least one core disc of the at least two core discs including:
an inner circumferential surface; and
at least one adhesive receptacle projecting radially into the inner circumferential surface.

14. The laminated core according to claim 13, wherein the at least one adhesive receptacle has a radial depth of 0.5 mm to 0.7 mm.

15. The laminated core according to claim 14, wherein the at least one adhesive receptacle has a radial depth of 0.2 mm.

16. The laminated core according to claim 13, wherein the at least one adhesive receptacle includes a plurality of adhesive receptacles disposed spaced apart from one another in a circumferential direction.

17. A rotor for an electrical motor, comprising:
a laminated core including at least two core discs;
the at least two core discs each including:
an inner circumferential surface; and
at least one recess projecting radially into the inner circumferential surface;
a main shaft;
a drive flange;
a balancing disc; and
adhesive disposed at least partially within the at least one recess of each of the at least two core discs;
wherein the laminated core is radially bonded to the main shaft via the adhesive.

18. The rotor according to claim 17, wherein the at least one recess includes a plurality of recesses disposed spaced apart from one another in a circumferential direction.

19. The rotor according to claim 17, wherein the adhesive includes an anaerobic adhesive film.

20. The rotor according to claim 19, wherein the laminated core is connected to the main shaft via a shrink-bonding fit.
